(19) United States
(12) Patent Application Publication
(10) Pub. No.: US 2006/0263094 A1
(43) Pub. Date: Nov. 23, 2006

(54) Apparatus for mitigating the effects of polarization mode dispersion of a plurality of optical signals

(76) Inventors: Dario Setti, Montegrotto Terme (IT); Alessandro Schiffini, Milan (IT)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/546,257

(22) PCT Filed: Mar. 21, 2003
(86) PCT No.: PCT/EP03/03176

§ 371 Date: May 16, 2006

(51) Int. Cl. H04B 10/00

(52) U.S. Cl. 398/152

(57) ABSTRACT

A PMD mitigation apparatus for mitigating the effects of PMD of a plurality of input optical signals, has a processing unit having a first input for the plurality of input optical signals, a second input and an output; a feedback control unit having an input coupled to the output of the processing unit and an output coupled to the second input of the processing unit. Under the control of a control signal, the processing unit is adapted to act on the polarization of the plurality of input optical signals separately so as to obtain at its output an aggregate having a corresponding plurality of polarized optical signals having associated a maximum fraction of power of the plurality of input optical signals. The feedback control unit is adapted to receive at its input a power portion of the aggregate of the plurality of polarized optical signals, to process the optical power portion so as to generate the control signal to the second input of the processing unit.

The present invention relates to an apparatus for mitigating the effects of polarization mode dispersion of a plurality of optical signals, an optical communication line and an optical communication system comprising the same and a method for mitigating the effects of polarization mode dispersion of a plurality of optical signals.

The characteristics of the optical pulses which propagate in an optical fiber are altered, among other things, due to the intrinsic birefringence of an optical fiber. The intrinsic birefringence is mainly due to manufacturing imprecision which cause, for example, a geometry of the core which is not perfectly circular and/or internal asymmetries.

An optical pulse propagates along an optical fiber according to two fundamental linear polarization modes perpendicular to each other which, due to the birefringence of the fiber, propagate along it with group velocities different from each other. In other words, the two modes undergo different time delays. This phenomenon, usually defined as Polarization Mode Dispersion (PMD), can cause a time spreading of the optical pulses (which in some cases can also result in a division of them into two separate pulses). The time distance between the two perpendicular polarization modes is known as differential group delay (DGD).

Such a delay limits the maximum transmission bit rate of an optical communication system and thus the performance thereof.

Moreover, the fundamental polarization modes and the differential group delay change in time in a stochastic way (for example due to variations in external temperature, displacements of the fiber and vibrations) making the PMD a random phenomenon which is difficult to predict.

Another problematic characteristic of PMD consists in the fact that the aforementioned differential group delay depends upon the frequency. In other words, different spectral components of an optical pulse can undergo different delays.

Furthermore, it is worth noting that the distances covered by optical signals along an optical communication line without undergoing any opto-electronic regeneration can be very long thanks to the insertion of optical amplifiers in said line. This, however, contributes to increase the PMD accumulation along a transmission line and thus to worsen the performance of the optical communication system at the receiver.

Up to now various devices and/or methods have been proposed to reduce the PMD in a single-channel optical communication system.

For example, FR 2 795 184 discloses a PMD compensation device comprising a polarization converter, a polarization beam splitter and a feedback control circuit. The polarization converter is adapted to convert an optical input signal with any state of polarization into a linear state of polarization having a desired angle. The polarization beam splitter separates the optical signal coming from the polarization converter into two perpendicular polarization components (for example TE and TM) allowing only one of the two components to exit and suppressing the other. The control circuit comprises a photo-detector and a pass band electrical filter to extract a spectral component from the electrical signal at its input. Moreover, it is adapted to control the polarization converter so as to maximize the spectral component in output from the electrical filter. In other words, the polarization converter—suitably driven by the control circuit—converts the state of polarization of the optical input signal into a linear state of polarization with an angle such as to maximize the spectral component in output from the electrical filter. The Applicants note that the feedback is carried out on the basis of a single spectral component of the electrical signal.

Henrik Sunnerud et al. (“A comparison between different PMD-compensation techniques”, Journal of Lightwave Technology, Vol. 20, No. 3, March 2002, pages 368-378) and M. Karlsson et al. (“A comparison of different PMD-compensation techniques”, ECOC 2000, vol. 2, pages 33-35), analyze and compare the performance of different PMD-compensation techniques. The techniques analyzed are: the “PSP” method which essentially consists in aligning the state of polarization of a signal inputted to an optical communication line with one of the principal states of polarization (PSPs); the first-order post compensation method, “1^{st}”, which consists in compensating the differential group delay (DGD) and the PSP by using a compensation element with both tunable DGD and PSP; the “1st-av” method which essentially consists in the “1st” method in which, however, the DGD is constant; the “Pol” method which essentially consists in maximizing the transmitted energy by using—at the end of a fiber optic link—a polarizer, a polarization controller and a feedback circuit; and a combination of such methods.

The Applicants note that while the “Pol” method has the advantage of being comparatively inexpensive and simple to implement, the other methods all require the use of a complicated and expensive control and feedback circuit. Moreover, some of them require the use of delay lines which are complex to implement.

EP 1 100 217 discloses an optical communication system with a plurality of PMD compensators in cascade between one span and the other of the system. Each PMD compensator comprises a polarization adjustment section, a first and a second polarization beam splitter, a delay optical system, a first and a second control circuit and a PMD detector. The first beam splitter separates the optical signal into two components with two states of polarization L1 and L2. The component L1 is made to pass through the delay optical system and then combined again with the component L2 by the second beam splitter. The PMD detector detects the distortion of the optical signal due to PMD and accordingly controls the two control circuits. These circuits control the optical delay system and the polarization adjustment section so as to minimize the distortion of the signal due to PMD at the output of the compensation device. However, the Applicants note that this compensation device only carries out a first order compensation (that is, of the differential group delay), ignoring the higher order PMD (i.e. the factors of PMD dependent upon the frequency). Furthermore, it requires the use of a complicated and expensive control and feedback circuit and the use of delay lines which are complex to implement.

In case of multi-channel transmission (e.g. of a Wavelength Division Multiplexed or WDM signal comprising a plurality of N optical signals with wavelengths λ1, . . . λN different from each other), this document teaches to use a wavelength splitter to split the WDM signal into the plurality of N optical signals; a number N of PMD compensation circuits (of the type disclosed for single channel transmission) in parallel for compensating the PMD of a respective optical signal and a multiplexer to multiplex the N optical signals in output from the PMD compensation circuits into an output WDM signal.

In view of the fact that the polarization evolution of different channels changes independently of one others, especially in the high-PMD regime, the Applicants observe that this multi-channel PMD compensation circuit compensates for the PMD of each individual signal (or channel) independently of the others. However, it has the drawback of increasing the structural complexity, the size and the cost of the multi-channel PMD compensation circuit.

EP 1 100 217 also discloses further embodiments of multi-channel PMD compensation circuits wherein the PMD compensation circuits in parallel each compensate for the PMD of a respective group of optical signals so as to reduce the number of PMD compensation circuits in parallel and to miniaturize the whole multi-channel PMD compensation circuit.

However, in view of what said above, the Applicants observe that, in these embodiments wherein the PMD of groups of optical signals as a whole is compensated for, the polarization evolution of each single channel is not taken into account so that the PMD of each single channel may not be effectively compensated for, especially in the high-PMD regime. Moreover, it may happen that a multi-channel PMD compensation circuit according to these embodiments deteriorates the characteristics of an optical signal slightly affected by PMD.

WO 01/67644 discloses a technique for PMD compensation in WDM channels by processing all WDM channels in the same manner without demultiplexing the channels. The compensating scheme disclosed comprises a single polarization controller for all WDM channels, a polarization maintaining fibre for introducing a delay between the two orthogonal polarizations in each WDM channel, an optical coupler to tap a small PMD monitor signal from the main WDM signal and a feedback control loop. The feedback control loop is used to receive and process the PMD monitor signal and to produce a control signal for controlling the polarization controller. This feedback control loop measures the degree of the total degradation of the combined WDM channels and adjusts the amount of DGD it produces in the main WDM signal to optimally decrease the DGD for the worst WDM channel.

However, in view of what said above, the Applicants observe that since the polarization evolution of each single channel is not taken into account by this technique, the PMD of each single channel may not be effectively compensated for, especially in the high-PMD regime. Moreover, it may happen that a multi-channel PMD compensation circuit according to these embodiments deteriorates the characteristics of an optical signal slightly affected by PMD.

The Applicants faced the technical problem of simply and effectively mitigating the effects of PMD of a plurality of optical signals while keeping the number of components and the size of the PMD mitigation apparatus limited.

The Applicants found that this can be obtained by using a PMD mitigation apparatus adapted to process a plurality of input optical signals so as to obtain in output a corresponding plurality of polarized optical signals having associated a maximum fraction of the power of the aggregate of input optical signals wherein the processing is performed by acting on the polarization of the input optical signals separately, under the control of a single feedback control unit which uses a portion of the optical power of the aggregate of polarized optical signals as feedback signal.

It is therefore a first aspect of the invention a PMD mitigation apparatus for mitigating the effects of PMD of a plurality of input optical signals, the device comprising
a processing unit having a first input for the plurality of input optical signals, a second input and an output;
a feedback control unit having an input coupled to the output of the processing unit and an output coupled to the second input of the processing unit;

wherein
under the control of a control signal, the processing unit is adapted to act on the polarization of the plurality of input optical signals separately so as to obtain at its output an aggregate comprising a corresponding plurality of polarized optical signals having associated a maximum fraction of power of the plurality of input optical signals; and
the feedback control unit is adapted to receive at its input a power portion of the aggregate comprising the plurality of polarized optical signals, to process said optical power portion so as to generate said control signal and to supply said control signal to the second input of the processing unit.

In the apparatus of the invention—wherein the PMD mitigation is carried out by providing in output a plurality of polarized optical signals with maximization of the transmitted optical power—the processing and feedback units are relatively simple to make. Moreover, the Applicants found that the use of a single feedback unit for processing the optical power of the aggregate of the polarized optical signals as a whole in combination with a processing unit adapted to act on the polarization of each single optical signal independently of the polarization of the other signals allows, as shown below, the PMD of a plurality of optical signals to be effectively mitigated and, at the same time, the number of components, the size and the cost of the PMD mitigation apparatus to be contained.

The Applicants observe that the PMD mitigation apparatus of the invention is adapted to search at predetermined time intervals the maximum of the power which can be obtained for the aggregate of the plurality of polarized optical signals, so as to obtain in output the maximum fraction of the power of the aggregate of the plurality of input optical signals or a value about such a maximum fraction. At each predetermined time interval, the optical power associated with the aggregate of polarized optical signals in output from the PMD mitigation apparatus is the result of said search for the maximum. With typical feedback circuits currently available, said search result can not-be precisely the maximum power fraction of the aggregate of optical signals in input but a value close to it.

Therefore, for the purposes of the present description and claims the expression “a maximum power fraction” is used to indicate the maximum fraction of the power of the aggregate of input optical signals or a value about such a maximum fraction;

In the present description and claims, the expression “polarized optical signal” is used to indicate an optical signal with a Degree of Polarization (DOP) of at least 0.9. Preferably, such an expression is used to indicate an optical signal having a degree of polarization of at least 0.95.

In turn, the expression “degree of polarization” is intended to indicate the percentage of the total power of an optical signal which is polarized. It is defined, at a point z, by the following relationship

$$DOP = \frac{\sqrt{{〈 {s}_{1} ( z , t ) 〉}_{T}^{2} + {〈 {s}_{2} ( z , t ) 〉}_{T}^{2} + {〈 {s}_{3} ( z , t ) 〉}_{T}^{2}}}{{〈 {P}_{0} ( z , t ) 〉}_{T}}$$

in which < >_{T} indicates the, time average in an interval T, P₀ is the optical power associated with the train or pattern of pulses upon which the measurement is carried out, s1, s2 and s3 are the parameters of a versor known in the art as Stokes versor s defined by the following relationships:

$$s = \frac{1}{{S}_{0}} ( \begin{matrix}{S}_{1} \\ {S}_{2} \\ {S}_{3}\end{matrix} ) = ( \begin{matrix}{s}_{1} \\ {s}_{2} \\ {s}_{3}\end{matrix} )$$

in which
S₀=|Eₓ|²+|E_{y}|²;
S₁=|Eₓ|²−|E_{y}|²;
S₂=EₓE*_{y}+E*ₓE_{y};
S₃=i(E*ₓE_{y}−EₓE*_{y})
where the asterisk indicates the conjugated complex operation and E=(Eₓ, E_{y}) is a complex vector known in the art as Jones vector which describes an electric field which propagates in optical fiber in an orthogonal Cartesian reference. In general for an optical signal which propagates in optical fiber the aforementioned Stokes versor s is a function of the position z and of the frequency. It follows that, in general, the spectral components of the signal have a different polarization and that, therefore, in the time domain, the state of polarization of the signal varies along the time profile of the pulse causing its depolarization. In general, for a perfectly polarized pulse the DOP is equal to 1, whereas it tends towards zero in the case of marked depolarization.

The DOP can be measured through, devices available on the market like, for example, the polarization analyzer AGILENT 8509B/C. The operation of such a device is described in the Product Note 8509-1 from the company Agilent Technologies available on Mar. 14, 2003 at the following Internet address: http://cp.literature.agilent.com/litweb/pdf/5091-2879E.pdf.

In the present description and claims, the expression “a plurality of optical signals” is used to indicate at least two optical signals having central wavelength different from each other.

In the present description and claims, the expression “acting on the polarization of an optical signal” is used to indicate the action of adjusting, converting, rotating or changing the state or states of polarization of the signal and/or the action of tuning in to or selecting a state of polarization of the signal.

The dependent claims relate to particular embodiments of the invention.

Typically, said optical signals are wavelength division multiplexed (WDM) signals.

Typically, said polarized optical signals in output from the processing unit are linearly polarized.

Advantageously, the processing unit comprises a plurality of optical paths, one for each of said plurality of optical signals.

Advantageously, each optical path comprises a device adapted to act on the polarization of the respective optical signal.

In an embodiment, said device acting on the polarization of the signal comprises a polarization controller adapted to adjust the polarization of the respective optical signal under the control of the control signal supplied by the feedback control unit. In this embodiment, the processing unit advantageously comprises, at the exit of the plurality of optical paths, a polarizer acting on the plurality of optical signals so as to obtain at its output the plurality of polarized optical signals all polarized according to a same predetermined (prefixed) state of polarization, the adjustment introduced by the polarization controller in each optical path being such as to maximize the optical power associated with the aggregate of said polarized optical signals in output from the polarizer. Typically, such a state of polarization is linear. According to a variant, instead of a single polarizer at the exit of the plurality of optical paths, in the processing unit each optical path further comprises a polarizer acting on the respective optical signal so as to obtain at its output a polarized optical signal according to a predetermined (prefixed) state of polarization, the adjustment introduced by the polarization controller in each optical path being such as to maximize the optical power associated with the aggregate of said polarized optical signals in output from the processing unit.

In an alternative embodiment, said device adapted to act on the polarization of the respective optical signal comprises a tunable polarizer which, under the control of the control signal supplied by the feedback unit, is adapted to obtain in output a respective polarized optical signal so as to maximize the optical power associated with the aggregate of said polarized optical signals in output from the processing unit.

Advantageously, the processing unit further comprises a separation/combination device adapted to separate the plurality of input optical signals and to supply each signal to the respective optical path. According to an embodiment, said separation/combination device is also adapted to collect the optical signals after propagation along the respective optical paths and to combine them again.

In an embodiment, said separation/combination device comprises a demultiplexing device having an input for receiving the aggregate of said plurality of input optical signals and a plurality of outputs connected to the inputs of said plurality of optical paths, said demultiplexing device being adapted to separate said input optical signals and to supply them to the respective optical paths. In this embodiment, said separation/combination device advantageously also comprises a multiplexing device having a plurality of inputs connected to the outputs of said plurality of optical paths and an output, said multiplexing device being adapted to combine on said output the optical signals coming from the plurality of optical paths.

In an alternative embodiment, said separation/combination device comprises an optical circulator having an input port for the plurality of input optical signals and a plurality of ports each connected to one of the optical paths.

Typically, the optical circulator also comprises an output port for the optical signals coming from the optical paths. Preferably, in this embodiment, each optical path comprises, at a first end thereof in proximity to the respective port of the optical circulator, a pass band filter adapted to let the respective optical signal pass and to reflect back the other optical signals. Advantageously, each optical path also comprises, at a second end thereof opposite the first end, a reflecting element adapted to reflect back, towards the respective port of the optical circulator, the respective optical signal. Advantageously, the reflecting element has a variable reflection coefficient and each optical path comprises a control circuit of said reflection coefficient so as to regulate the level of optical power of the respective polarized optical signal.

Advantageously, the PMD mitigation apparatus also comprises a power regulating device adapted to regulate the power of the plurality of polarized optical signals separately. Advantageously, said power regulating device is adapted to substantially equalize the power of the plurality of polarized optical signals at the output of the processing unit. In an embodiment, said power regulating device comprises a plurality of optical attenuators each associated with a respective optical signal. In an alternative embodiment, said power regulating device comprises a plurality of optical amplifiers each associated with a respective optical signal. According to a further embodiment, said power regulating device comprises a dynamic gain equalizer at the output of said processing unit.

Advantageously, the PMD mitigation apparatus also comprises an optical coupler adapted to tap the power portion of the aggregate of the plurality of polarized optical signals from the output of the processing unit and to supply it to the input of the feedback control unit.

In an embodiment, the PMD mitigation apparatus comprises an optical amplifier. The optical amplifier advantageously allows possible power losses introduced on the optical signals by the PMD mitigation apparatus (and, in particular, by the polarizers) to be compensated for. Preferably, the optical amplifier is positioned at the output of the processing unit.

In a second aspect thereof, the invention also relates to an optical communication line for transmitting a plurality of optical signals comprising at least one span and at least one PMD mitigation apparatus according to the invention.

As far as the structural and functional characteristics of the PMD mitigation apparatus are concerned reference is made to what described above.

In the present description and claims, the expression “span” is used to indicate a portion of optical communication line used for the transmission of optical signals from one point to another situated at an appreciable distance (for example, of at least some km or tens of km). Typically, the span comprises a transmission optical fiber suitable for the transmission of signals from one point to another situated at an appreciable distance. Typically, the span also comprises a chromatic dispersion compensation device.

In the present description and claims, the expression “a plurality of spans” is used to indicate at least two spans.

Advantageously, each span comprises a transmission optical fiber length.

According to an embodiment, the PMD mitigation apparatus is located at the output end of the line.

Typically, the optical communication line comprises a plurality of spans.

As shown in the international patent application PCT/IT02/00708, incorporated here by reference, the use of one or more PMD mitigation apparatuses of the type adapted to provide in output a polarized optical signal with maximization of the transmitted optical power within an optical communication line (i.e. between the spans of the line), instead of or as well as at the end of the link, allows the effects of PMD to be substantially reduced and, therefore, the performance of an optical communication system to be improved. Indeed, as shown in said PCT patent application, due to the PMD the degree of polarization of an optical signal can significantly decrease as the signal propagates along the optical communication line and a suitable repolarization of the signal within the optical communication line allows the PMD of the line to be remarkably reduced.

Advantageously, the PMD mitigation apparatus of the invention is located between two spans of the line according to the teachings of the international patent application PCT/IT02/00708. Since the apparatus of the invention is of the above mentioned type (that is, it adapted to provide in output polarized optical signals with maximization of the transmitted optical power), its use between two spans of the line allows the effects of PMD to be substantially reduced and, therefore, the performance of an optical communication system to be improved.

In a preferred embodiment, the optical communication line comprises, at its output end, a further PMD mitigation apparatus. This allows, when needed and depending on the system requirements, the PMD to be compensated even at the end of the line (typically immediately upstream of the receiving station of an optical communication system). As far as the characteristics of this further PMD mitigation apparatus are concerned reference is made to what described above.

Advantageously, the optical communication line comprises at least one optical amplifier. Typically, the optical amplifier is positioned between two spans of the line. This allows the optical signals to be amplified after propagation along the upstream span. Advantageously, said optical amplifier is associated with the PMD mitigation apparatus.

Preferably, at least one of the spans also comprises a chromatic dispersion compensation device. Advantageously, the aforementioned PMD mitigation apparatus is associated with said chromatic dispersion compensation device. In an embodiment, the line comprises a further PMD mitigation apparatus associated with the chromatic dispersion compensation device. As far as the characteristics of this further PMD mitigation apparatus are concerned reference is made to what described above. Typically, the chromatic dispersion compensation device comprises an optical fiber.

Advantageously, the optical communication line comprises a plurality of PMD mitigation apparatuses cascaded among the spans of the line. As far as the characteristics of these further PMD mitigation apparatuses are concerned reference is made to what described above.

In a third aspect thereof, the invention also relates to an optical communication system comprising an optical communication line as described above, a transmitting station adapted to supply said plurality of optical signals to the line and a receiving station to receive said plurality of optical signals from the line.

As far as the structural and functional characteristics of the line and of the PMD mitigation apparatus are concerned reference is made to what described above.

In a fourth aspect thereof, the present invention also relates to a method for mitigating the effects of the PMD of a plurality of optical signals, said method comprising the steps of
a) acting, under the control of a control signal, on the polarization of the plurality of optical signals separately so as to obtain an aggregate of a corresponding plurality of polarized optical signals,
b) providing a power portion of the aggregate of the plurality of polarized optical signals,
c) processing the optical power portion provided in step b) so as to generate the control signal to be used in step a) so that the aggregate of the corresponding plurality of polarized optical signals has associated a maximum fraction of power of the aggregate of said plurality of optical signals.

Typically, in step a) the polarized optical signals are linearly polarized.

According to an embodiment, step a) is carried out by obtaining the optical signals each polarized according to a predetermined state of polarization and by adjusting, under the control of said control signal, the polarization of each single optical signal so as to maximize the optical power associated with the aggregate of said optical signals each polarized according to said predetermined state of polarization.

Advantageously, in step a) the polarized optical signals are all polarized according to a same predetermined state of polarization and the polarization of each single optical signal is adjusted so as to maximize the optical power associated with the aggregate of said optical signals polarized according to the same predetermined state of polarization.

Characteristics and advantages of the invention shall now be illustrated with reference to embodiments represented as a non-limiting example in the attached drawings in which:

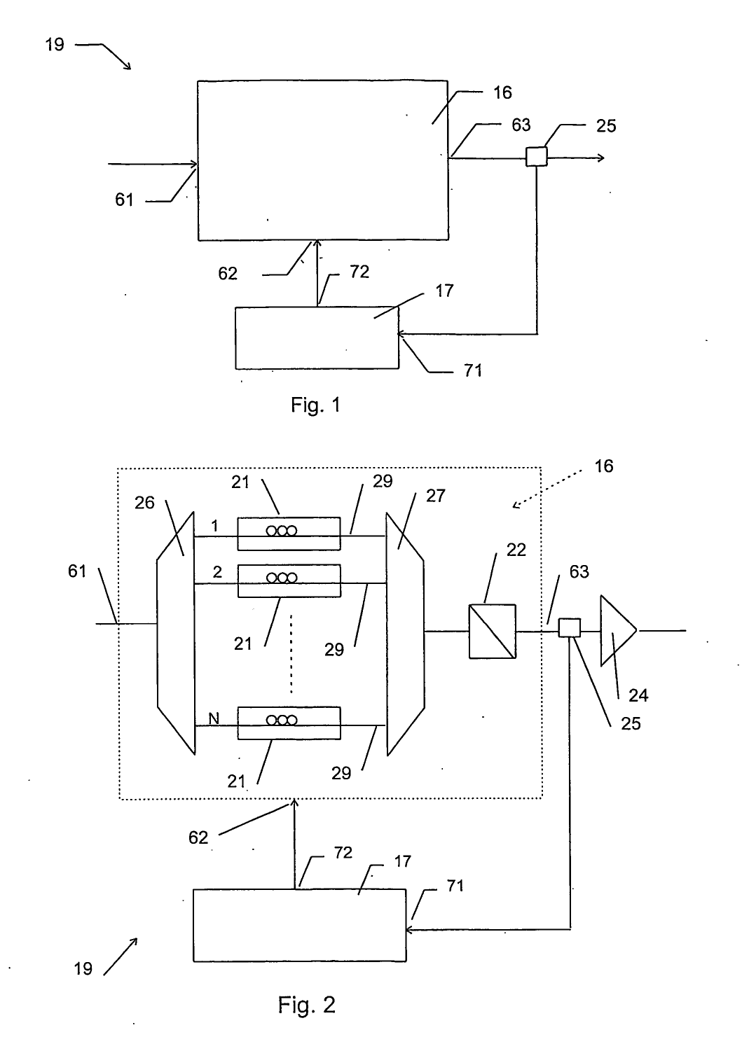

FIG. 1 shows a PMD mitigation apparatus according to the invention;

FIG. 2 shows a first embodiment of a PMD mitigation apparatus of the invention;

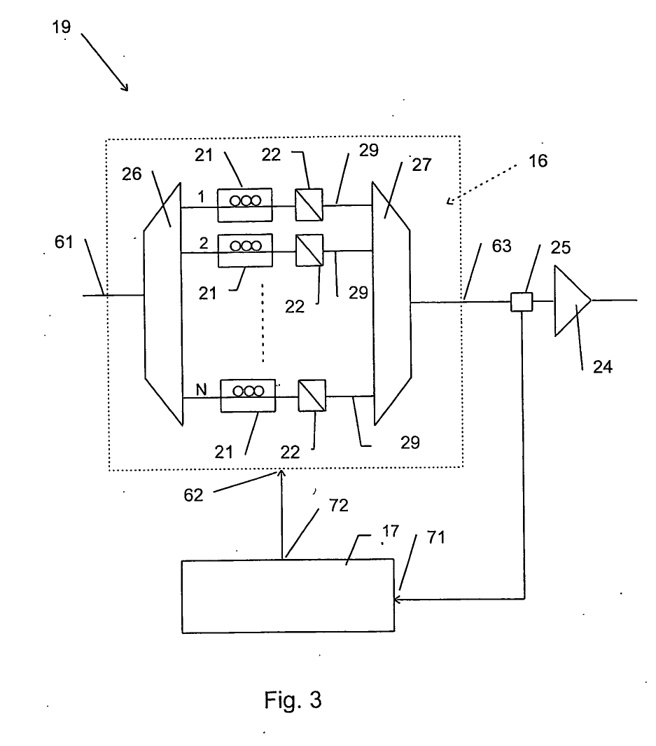

FIG. 3 shows a second embodiment of a PMD mitigation apparatus of the invention;

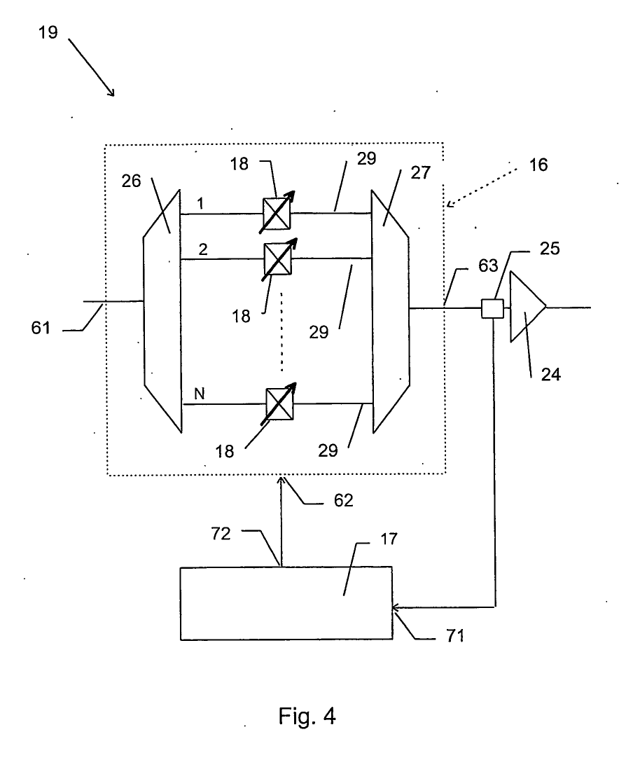

FIG. 4 shows a third embodiment of a PMD mitigation apparatus of the invention;

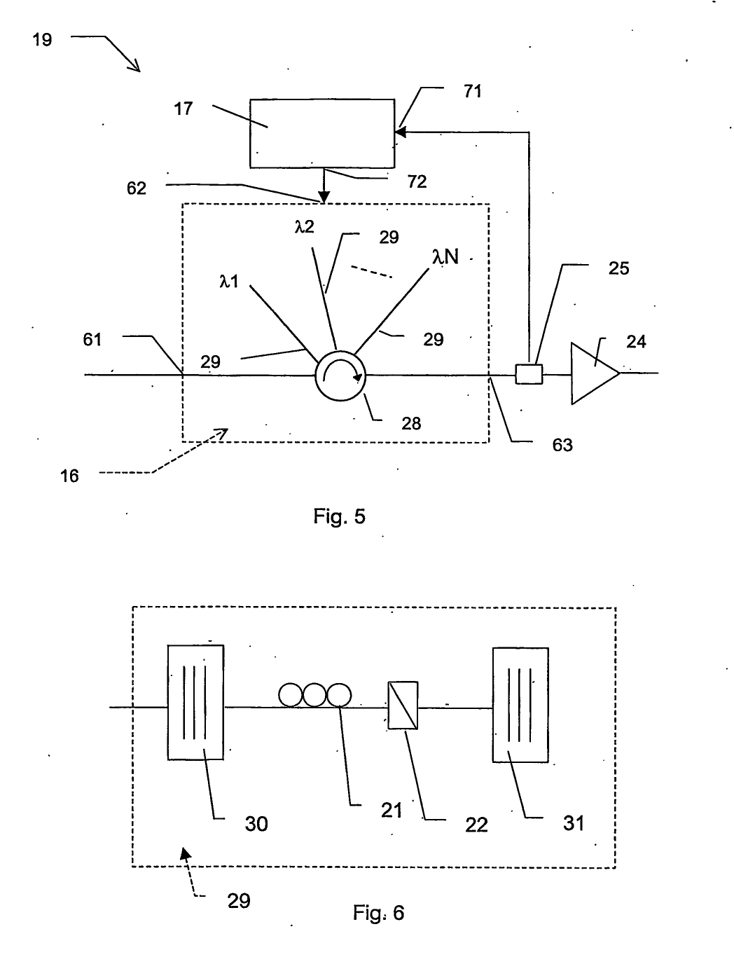

FIG. 5 shows a fourth embodiment of a PMD mitigation apparatus of the invention;

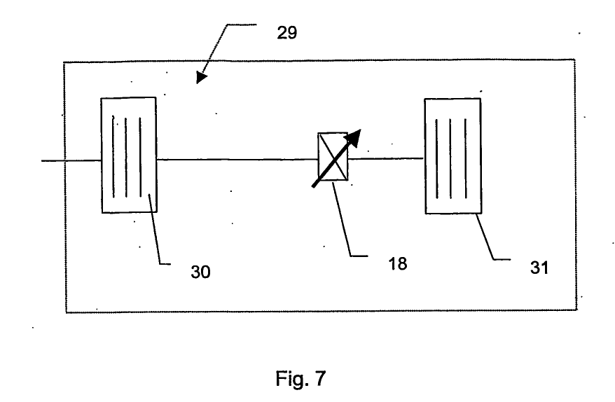

FIG. 6 shows a first embodiment of an optical path of the PMD mitigation apparatus of FIG. 5;

FIG. 7 shows a second embodiment of an optical path of the PMD mitigation apparatus of FIG. 5;

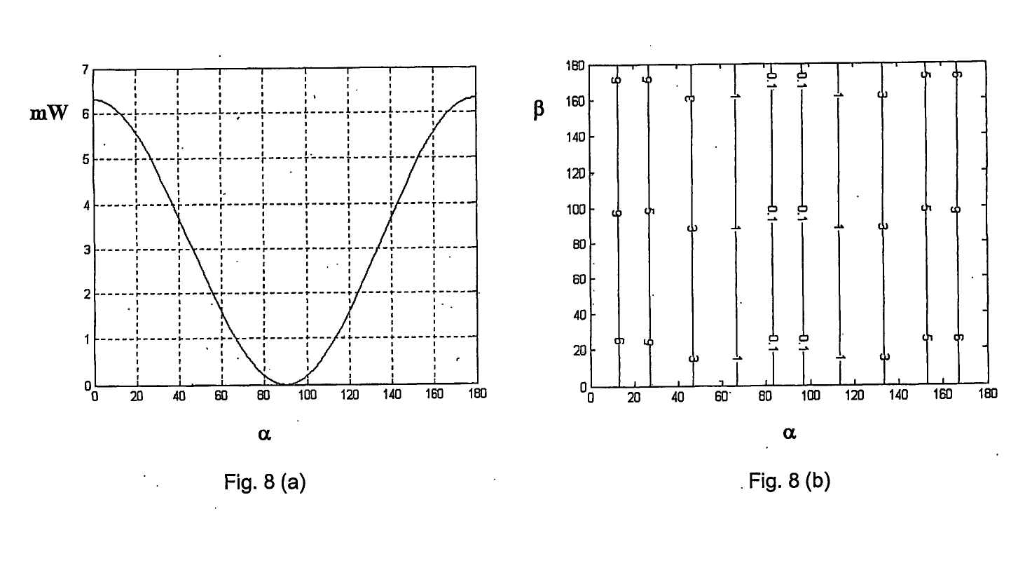

FIGS. 8a and 8b show the WDM optical power versus the SOP (described by α and the couple (α, β), respectively, as defined hereinafter) in case of two fully and vertically polarized channels,

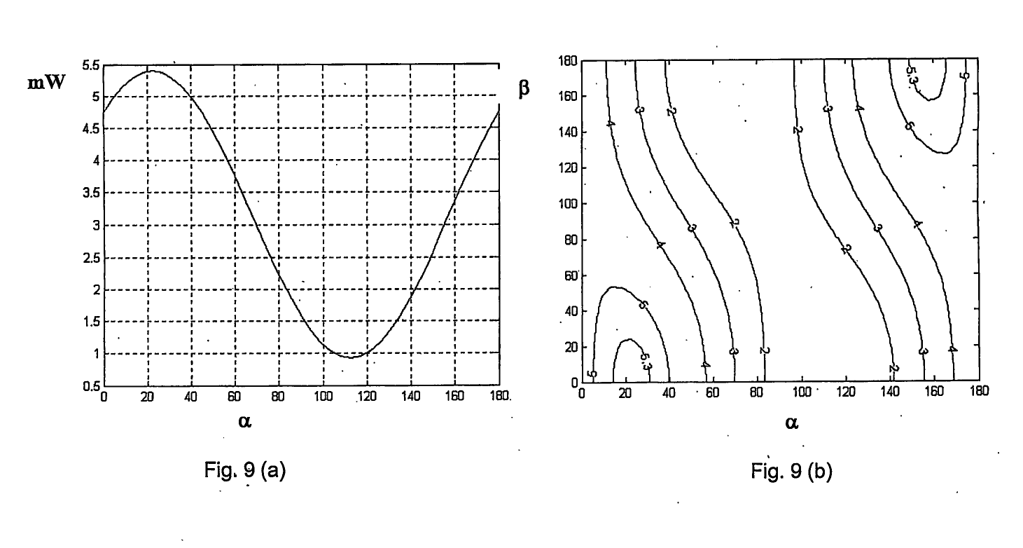

FIGS. 9a and 9b show the WDM optical power versus the SOP (described by α and the couple (α, β), respectively, as defined hereinafter) in case of two fully and linearly polarized channels, wherein one channel is vertically polarized while the other channel is 45 degrees oriented;

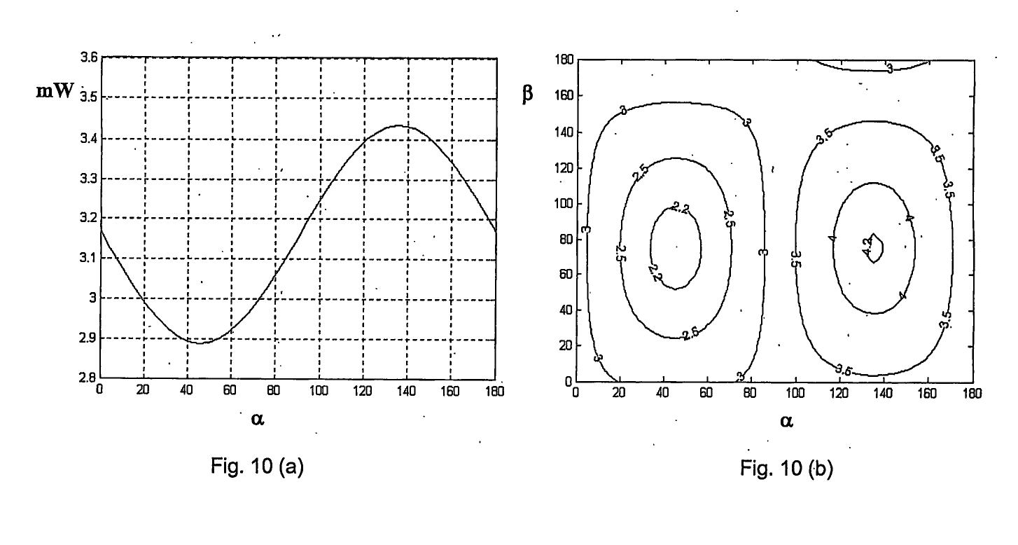

FIGS. 10a and 10b show the WDM optical power versus the SOP (described by a and the couple (α, β), respectively, as defined hereinafter) for the same case as FIG. 9 except for the fact that PMD degradation of the channels was considered;

FIG. 11 shows an optical communication line according to the invention;

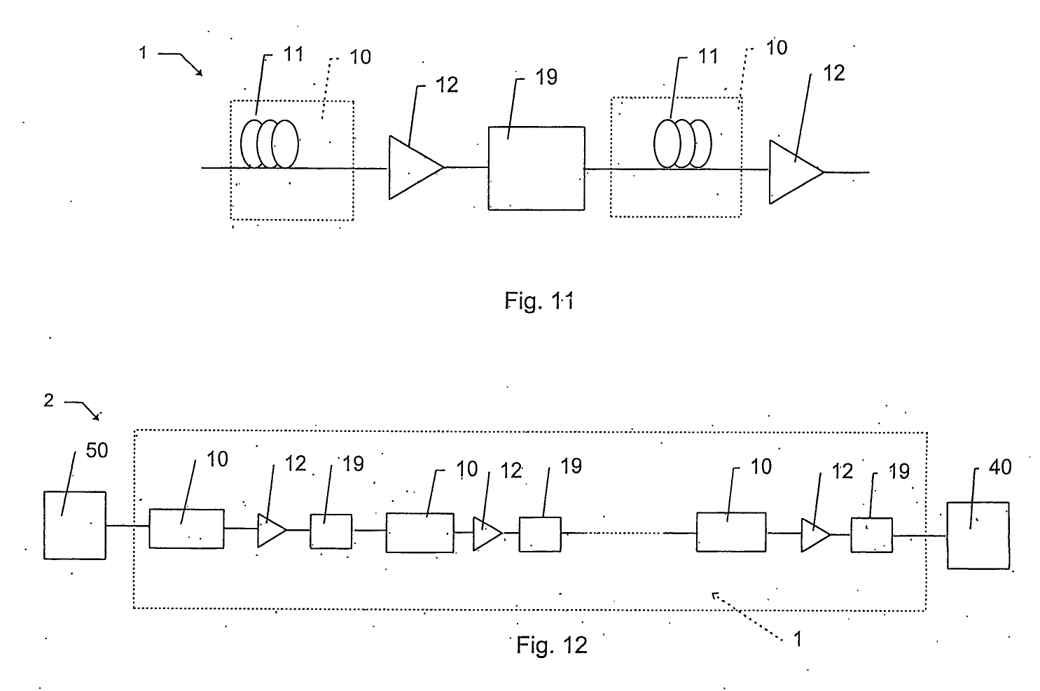

FIG. 12 shows an optical communication system according to the invention.

FIG. 1 shows a PMD mitigation apparatus 19 according to the invention comprising a processing unit 16—having a first input 61, a second input 62 and an output 63—and a feedback control unit 17 having an input 71 and an output 72.

The first input 61 of the processing unit 16 is adapted to receive a plurality of N input optical signals (channels). Typically, said plurality of input optical signals are WDM signals coming from an optical communication line span. The second input 62 of the processing unit 16 is coupled to the output 72 of the feedback control unit 17 and the output 63 of the processing unit 16 is coupled to the input 71 of the feedback control unit 17.

Typically, the PMD mitigation apparatus 19 also comprises an optical coupler 25 at the output 63 of the processing unit 16.

In the PMD mitigation apparatus 19

the processing unit 16 is adapted to act, under the control of a control signal, on the polarization of each single input optical signal separately from the polarization of the other input optical signals so as to obtain at the output 63 an aggregate of a corresponding plurality of polarized optical signals,

the coupler 25 is adapted to tap a small power portion (for example 5%) of the aggregate of the plurality of polarized optical signals from the output 63 and to supply it to the input 71 of the feedback control unit 17,

the feedback control unit 17 is adapted to process the optical power portion received at its input 71, to generate said control signal and to supply it to the second input 62 of the processing unit 16. Such control signal controls the processing unit 16 so that at the output 63 the aggregate of the corresponding plurality of polarized optical signals has associated a maximum fraction of the optical power associated with the aggregate of said input plurality of optical signals.

As shown in FIGS. 2 to 5, typically the processing unit 16 comprises a plurality of N optical paths 29, one for each optical signal, and a separation/combination device 26, 27, 28 adapted to receive the plurality of N optical signals from the input 61, separate said N optical signals, supply them to the respective optical paths 29 and combine the optical signals after propagation through the N optical paths 29 on the output 63.

In particular, in the embodiment shown in FIG. 2, the processing unit 16 comprises a plurality of N optical paths 29 in parallel; a demultiplexing device 26 having an input for receiving said plurality of N optical signals from the input 61 and N outputs connected to said N optical paths 29; and a multiplexing device 27 having N inputs connected to said N optical paths 29 and an output.

Furthermore, the processing unit 16 further comprises a polarization controller 21 in each optical path 29 and a polarizer 22 at the output of the multiplexer 27.

Advantageously, the PMD mitigation apparatus 19 of FIG. 2 further comprises an optical amplifier 24 coupled at the output 63 of the processing unit 16.

The demultiplexing device 26 is adapted to separate said N optical signals onto the different optical paths 29 according to their wavelength while the multiplexing device 27 is adapted to combine on its output the optical signals coming from the N optical paths 29.

The demultiplexing device 26 comprises, for example, a conventional fused fiber or planar optics coupler, a Mach-Zehnder device, an AWG (Arrayed Waveguide Grating), an interference filter and/or a micro-optic filter and the like.

The multiplexer device 27 comprises, for example, a conventional fused fiber or planar optical coupler, a Mach-Zehnder device, an AWG (Arrayed Waveguide Grating), an interference filter and/or a micro-optic filter and the like.

The optical amplifier 24 preferably operates in saturation. In other words, it has a constant output power, value, independently of the power value of the aggregate of optical signals at its input. This ensures that the aggregate of polarized optical signals at the output of the apparatus 19 always has the same power value.

Typically, the optical amplifier 24 is of the active optical fiber conventional type. For example, it comprises a length of active optical fiber doped with erbium and a pump source (not shown)—for example a laser source—to pump the active optical fiber at a pumping wavelength λp.

According to the needs of the system, the optical amplifier 24 may comprise more than one amplification stage and/or more than one pump source.

In the case of erbium doped active optical fiber, the wavelength λp of the pumping signal is typically equal to about 980 or 1480 nm.

Moreover, the optical amplifier 24 can possibly also comprise an optical isolator for blocking the backward reflections of the optical signals.

According to the embodiment of FIG. 2, the PMD mitigation apparatus 19 is adapted to supply at the output 63 a plurality of N optical signals all polarized according to a same prefixed state of polarization (aligned with that of the polarizer 22) and to adjust (by means of the polarization controllers 21 and under the control of the feedback control unit 17) the polarization of each input optical signal individually so as to maximize at the output 63 the optical power associated with the aggregate of optical signals polarized according to said prefixed state of polarization.

In particular, each polarization controller 21 is adapted to convert any state of polarization at its input into a linear state of polarization oriented according to a desired angle. The polarizer 22 is adapted to obtain in output an optical signal having a prefixed linear state of polarization. The feedback control unit 17 is adapted to control each polarization controller 21 through a respective control signal so as to maximize the optical power in output from the polarizer 22. In this way, each polarization controller 21 adjusts the polarization of the respective optical signal at its input so as to maximize the optical power in output from the polarizer 22.

More particularly, in the case in which an optical signal in input to a polarization controller 21 is a polarized signal (i.e. having only one polarization component) according to any state of polarization, the polarization controller 21 adjusts the state of polarization of the input optical signal so that it has, in input to the polarizer 22, a linear state of polarization substantially aligned with that of the polarizer 22. In this way, the polarizer 22 shall supply in output substantially 100% of the power of said input optical signal. On the other hand, in the more realistic case of an input optical signal partially depolarized due to propagation along an optical fiber span affected by PMD, such an optical signal will have many polarization components, with one of which most of the optical power of the signal will be associated. In this case, the polarization controller 21, adjusts the polarization of the input optical signal so that the polarization component with higher optical power has, in input to the polarizer 22, a linear state of polarization substantially aligned with that of the polarizer 22. Therefore, for each of the N optical signals, the polarizer 22 will supply in output substantially all of the power associated with the polarization component at higher optical power (since it has linear polarization substantially aligned with that of the polarizer 22) whereas of the other polarization components it will supply in output only their power contribution along the predetermined linear state of polarization of the polarizer 22.

Accordingly, at the output 63 of the processing unit 16 the maximum power achievable for each polarized optical signal is obtained so that the optical power of the aggregate of the N polarized optical signals is maximized.

The Applicants believe that for a signal not strongly depolarized the apparatus of the invention, by obtaining in output of the polarizer said polarization component at higher optical power, practically allows also to select the spectral components of the optical signal at higher optical power, that is, the central portion of the optical pulses. According to the Applicants, this is because the spectral components associated with the tails of an optical pulse (i.e., the spectral components at lower optical power) very likely have polarization components quite different from the polarization components of the central portion, due to the fact that they have been subjected, during propagation, to a polarization evolution quite different from that of the spectral components associated with the central portion. Thus, the apparatus of the invention can provide for a substantial part of the tails of an optical pulse to be removed. The Applicants note that such tails are typically responsible for intersymbol interference, which is among the worst effects caused by PMD. Thus, the apparatus of the invention allows the effects of PMD to be mitigated and, at the same time, an acceptable power level to be maintained.

This PMD mitigation technique can cause on each optical signal optical power losses which, however, can be compensated, as described hereafter. At most, there is a 50% power loss for each optical signal.

Moreover, different optical signals can experience different power losses due to the fact that the depolarization caused by PMD depends upon the optical signal wavelength.

On this purpose, the Applicants quantified this effect of optical signal power unbalancing through a numerical analysis. The analysis was performed considering a single channel transmission along five cascaded optical fiber spans, each comprising a 100 Km optical fiber length having a DGD mean value of 40 ps, a PMD mitigation apparatus comprising a polarization controller and a linear polarizer, and an optical amplifier. The maximum loss experienced by the single optical signal due to the PMD mitigation apparatus was around 0.5 dB, whereas the average loss was very low, about 0.06 dB. As a consequence, the power unbalancing of the optical signals due to PMD mitigation resulted to be reasonable and comparable with other propagation effects.

Any way, when required by system specifications, the PMD mitigation apparatus 19 of FIG. 2 can also comprise a power regulator device (not shown) for compensating for said power unbalancing of the optical signals. Typically, such a power regulator device is adapted to guarantee that the N optical signals at different wavelengths all substantially have the same optical power at the input of the optical amplifier 24 or, in any case, at the output of the apparatus 19. For example, such a power regulator device comprises a conventional dynamic gain equalizer arranged at the output of the amplifier 24 or, preferably, at the output 63. Alternatively, the power regulator device comprises a plurality of optical attenuators each arranged in a respective optical path between the polarization controller 21 and the input of the multiplexer 27. For example, such optical attenuators all have the same output power. Alternatively, it is possible to use variable attenuators and a suitable feedback circuit for each optical path, with the feedback circuits of the various optical paths suitably in communication with each other to substantially equalize the power of the optical signals at the output of the apparatus 19.

Moreover, instead of or as well as the optical amplifier 24, the PMD mitigation apparatus 19 can comprise a plurality of optical amplifiers (not shown), one for each optical path 29. In an embodiment, such optical amplifiers operate in saturation so as to have a constant output power. In this case, they can carry out the function of the aforementioned power regulator device.

As to the feedback control unit 17, it typically comprises a photo-detector (not shown) adapted to convert the portion of optical power tapped from the output 63 into an electrical signal. Moreover, it typically comprises an electronic circuit adapted to implement a maximum power search algorithm and to drive the polarization controllers 21 of the various optical paths 29 through respective control signals so as to seek a maximum value for the optical power in output from the processing unit 16.

Accordingly, in the PMD mitigation apparatus according to the invention, the feedback is carried out based upon a simple measurement of the power associated with the aggregate of the N polarized optical signals. With respect to the prior art described above, in which, for example, the feedback is based upon the measurement of the DOP (Degree of Polarization), the control used according to the invention is therefore much simpler to implement, faster and more reliable.

Furthermore, in the apparatus of the invention, wherein the processing unit acts on the polarization of the optical signals individually, the PMD is effectively mitigated even in the high-PMD regime when the depolarization experienced by each channel due to PMD is independent of those experienced by the other channels.

Moreover, in the apparatus of the invention, wherein a single feedback control unit is used for maximizing the power of the plurality of polarized optical signals as a whole, the structural complexity and the size of the multi-channel PMD mitigation scheme are contained.

FIG. 3 shows another embodiment of the PMD mitigation apparatus 19 of the invention which is similar to that of FIG. 2 except for the fact that it comprises a plurality of polarizers 22, one for each optical path 29, instead of the single polarizer of FIG. 2 at the output of multiplexer 27.

As far as the structural and functional characteristics of the PMD mitigation apparatus 19 in general, the optical amplifier 24, the polarization controllers 21, the polarizers 22, the demultiplexer 26, the multiplexer 27, the feedback control unit 17 are concerned reference is made to what described above.

As to the operation of the apparatus 19 of FIG. 3, it is similar to that of FIG. 2 except for the fact that in the PMD mitigation apparatus 19 of FIG. 3, wherein there is a polarizer 22 for each optical signal, the plurality of N polarized optical signals at the output 63 are not necessarily all polarized according to the same prefixed state of polarization. Indeed, at the output 63 each optical signal is polarized according to a prefixed state of polarization aligned with that of the respective polarizer 22.

FIG. 4 shows another embodiment of the PMD mitigation apparatus 19 of the invention which is similar to that of FIG. 3 apart from the fact that each optical path 29 comprises a tunable polarizer 18 (having variable output polarization state) instead of the couple polarization controller 21-polarizer 22 (with a fixed output polarization state). In this case, the feedback control unit 17 is adapted to command the tunable polarizer 18 of each optical path 29 with a respective control signal so that it supplies in output the state of polarization which maximizes, depending on the input signal, the power of the aggregate of polarized optical signals at the output 63 of the processing unit 16.

For example, tunable linear polarizers are available on the market from the company STANDA (Vilnius, Lithuania).

As far as the structural and functional characteristics of the PMD mitigation apparatus 19 in general, the optical amplifier 24, the demultiplexer 26, the multiplexer 27, the feedback control unit 17 are concerned reference is made to what described above.

Differently from the embodiments of FIGS. 2 and 3, the Applicants observe that at present in this embodiment even a fully polarized optical signal (i.e. having only one polarization component), but not linearly polarized, experiences power losses. This is due to the fact that tunable polarizers at present commercially available are linear polarizer devices (that is, they output only linear states of polarization). However, also in this case, the maximum power loss experienced by each optical signal is 3 dB.

Accordingly, the presence of the power regulator device (disclosed above with reference to the apparatus of FIG. 2) for compensating for the power unbalancing of the optical signals at the output of the apparatus 19 is preferred in this embodiment.

FIG. 5 shows another embodiment of the PMD mitigation apparatus 19 of the invention which is similar to that of FIG. 3 or 4 apart from the fact that the separation and combination of the signals is carried out by using a conventional optical circulator, a plurality of pass band filters, one for each signal, and a plurality of reflecting elements, one for each signal.

More in particular, the processing unit 16 of the PMD mitigation apparatus 19 of FIG. 5 comprises an optical circulator 28 having an input port to receive the plurality of N optical signals, N ports associated with N respective optical paths 29 and an output port for the aggregate of the plurality of polarized optical signals. Moreover, the PMD mitigation apparatus 19 advantageously also comprises an optical amplifier 24 connected to the output port 63 of the processing unit to amplify the optical signals in output from it.

According to the embodiment shown in FIG. 6, each optical path 29 comprises, in sequence, a pass band filter 30, a polarization controller 21, a polarizer 22 and a reflecting element 31.

As far as the structural and functional characteristics of the PMD mitigation apparatus 19 in general, the optical amplifier 24, the polarization controllers 21, the polarizers 22 and the feedback control unit 17 are concerned reference is made to what described above.

As in the embodiment shown in FIG. 3, the feedback control unit 17 is adapted to command the polarization controller 21 of each optical path 29 so as to maximize the power of the aggregate of polarized optical signals at the output 63 of the processing unit 16.

The pass band filter 30 typically comprises a fiber optic grating and is adapted to let the signal associated with the respective optical path 29 (for example the signal with wavelength λ2) pass and to reflect back all of the other signals (for example, the signals with wavelength λ1, λ3 . . . λN), towards the subsequent port of the optical circulator 28.

The reflecting element 31 typically comprises a fiber optic grating and is adapted to reflect back the optical signal at its input. Preferably, it has a substantially 100% reflectivity (subject to what said below with reference to the power regulator).

FIG. 7 shows an alternative embodiment for the optical paths 29 of the apparatus of FIG. 5. This embodiment is similar to that of FIG. 6 apart from the fact that—analogously to what disclosed with reference to FIG. 4—it comprises a tunable polarizer 18 instead of the couple polarization controller 21-polarizer 22.

As in the apparatus shown in FIG. 4, according to this embodiment the feedback control unit 17 is adapted to command the tunable polarizer 18 of each optical path 29 so that it supplies in output the state of polarization which maximizes, depending on the input signal, the power of the aggregate of polarized optical signals at the output 63 of the processing unit 16.

Coming back to FIG. 5, in the PMD mitigation apparatus 19 the optical, signals enter into the processing unit 16 through the input port of the optical circulator 28, they pass along the respective optical paths 29, they come out from the processing unit 16 through the output port of the optical circulator 28 and, finally, they are amplified by the optical amplifier 24. The feedback control unit 17 drives the polarization controller or tunable polarizer of each optical path 29 so as to maximize the optical power at the output 63 of the processing unit 16.

Analogously to what stated above, the PMD mitigation apparatus of FIG. 5 may also comprise a power regulator device (not shown) to compensate for the power unbalancing of the optical signals. As far as the characteristics of such a power regulation device is concerned reference is made to what described above.

Moreover, in this embodiment of the PMD mitigation apparatus 19, the power regulation can also be obtained through a reflecting element 31 with a variable reflection coefficient (for example, a reflecting element 31 comprising a fiber optic grating with a reflection coefficient variable with temperature) and a control circuit adapted to regulate such a reflection coefficient.

The multi-channel PMD mitigation scheme of the invention is based on the observation of the Applicants that in case of fibers with high E[DGD] (that is, high DGD mean value) and WDM systems with conventional ITU-T channel spacing, the evolution of the state of polarization (SOP) and the depolarization experienced by each channel due to PMD are independent of those experienced by the other channels. Furthermore, the scheme of the invention is the result of an investigation performed by the Applicants on the properties of the optical power of an aggregate of WDM optical channels (hereinafter referred to as WDM optical power) versus the SOP.

More in particular, the Applicants investigated the case of NRZ transmission of two WDM channels with 100 GHz channel spacing and a total optical power of 8 dBm (that is, about 6.3 mW).

The results of this analysis are shown in FIGS. 8-10 wherein linear SOPs are described in the Jones domain by means of a unit vector e=[cos(α) sin(α)]^{T}, where α is the angle between a fixed vertical axis and the direction of the SOP whereas [ ]^{T} indicates the transposition operator. Elliptical SOPs are represented by means of a Jones unit vector in the form e=[cos(α) sin(α)exp(iβ)]^{T}, where β is the phase difference between the two components of the electrical field that gives rise to elliptical SOPs.

FIGS. 8 and 9 show the results for an aggregate of two fully polarized WDM signals (simulating a propagation of the channels not affected by PMD).

In particular, FIGS. 8a and 8b show the WDM optical power versus β and the couple (α, β), respectively, in case of two fully polarized (DOP—as defined above—equal to 1) and linearly (in particular, vertically) polarized channels.

FIGS. 9a and 9b show the WDM optical power versus α and the couple (α, β), respectively, in case of two fully polarized channels (each having DOP=1), wherein one channel is vertically polarized while the other channel is linearly polarized and 45 degrees oriented.

FIGS. 10a and 10b show the WDM optical power versus α and the couple (α, β), respectively, for the same case as FIG. 9 except for the fact that PMD degradation of the channels was considered (DGD at the central wavelength of one of the two channels=11 ps and E[DGD]=40 ps).

In FIGS. 8a, 9a, 10a only linear SOPs are taken into account while in FIGS. 8b, 9b, 10b all possible SOPs are taken into account. Moreover, in FIGS. 8b, 9b and 10b the contour lines of the power corresponding to the various SOPs are shown.

In FIG. 8 there is only one WDM optical power maximum versus SOP for α=0=π (for any value of β in FIG. 8b) and it corresponds to the sum of the optical power of the two channels (that is, the WDM optical power is equal to 6.3 mW). For any value of β, the conditions α=0 and α=π represent the same SOP.

In FIG. 9a there is only one WDM optical power maximum for α=22.5°. Moreover, even if in FIG. 9b two maxima are visible, the conditions (α=22.5°, β=0) and (α=180°−22.5°, β=180°) represent the same SOP. Therefore, also in FIG. 9b only one WDM optical power maximum versus SOP is actually present. However, the condition α=22.5° neither correspond to the SOP of the first channel (α=0°) nor to the SOP of the second channel (α=45°). Therefore the value of said maximum is not the sum of the optical power of the two channels (about 6.3 mW) but less (about 5.4 mW).

Also in the case of FIG. 10 there is only one WDM optical power maximum. However, it is not the sum of the optical powers of the two channels and it has a value lower than in FIG. 9 due to PMD degradation. Moreover, it is noted that, due to PMD, the SOP characterized by the highest power is an elliptic one.

Accordingly, the analysis carried out by the Applicants shows that in the WDM optical power versus SOP graph only one maximum is present (no relative maxima are present). Based on this observation, the Applicants noticed that a single feedback control unit of the type disclosed above—which performs a maximum power search algorithm on the aggregate of optical signals—can be used. As stated above, the use of such a feedback control unit type offers several advantages in terms of complexity and size of the apparatus.

However, the Applicants observed that a PMD mitigation apparatus having a processing unit for acting—under the control of such a feedback control unit—on the polarization of the input optical signals as a whole (e.g., by means of a single couple of polarization controller-polarizer or by means of a single tunable polarizer) so as to obtain at its output an aggregate of corresponding polarized optical signals having associated a maximum fraction of power of the aggregate of the input optical signals would not allow to obtain for each channel the polarization component at higher optical power. Thus, in view of what said above, it would not allow the effects of the PMD to be effectively mitigated. Indeed, such a PMD mitigation apparatus having a processing unit for acting on the polarization of the input optical signals as a whole may also deteriorate the characteristics of fully polarized optical signals not affected or slightly affected by PMD.

For example, in case of FIG. 9 of two fully and linearly polarized channels, wherein one channel is vertically polarized while the other channel is 45 degrees oriented, such a type of PMD mitigation apparatus would introduce unjustified power losses on the channels only for the fact that an intermediate SOP (α=22.5°) is outputted.

Accordingly, the Applicants noticed that in order to effectively mitigating the PMD effects it is necessary to act (under the control of the above mentioned type of feedback control unit) on the polarization of the optical signals one by one so as to obtain at the output the highest value of power achievable for each channel.

For example, this is obtained by the alternative embodiments of the PMD mitigation apparatus of the invention of FIGS. 2-7.

In particular, in the embodiment of FIG. 2 said highest value is obtained by aligning the polarization component associated with the highest power of each channel with the linear state of polarization of the polarizer 22. In the embodiment of FIGS. 3-7 said highest value is achieved by obtaining in output for each channel the polarization component associated with the highest power.

The PMD mitigation apparatus of the invention can be used in an optical communication line or system for mitigating the effects of PMD of a plurality of optical signals.

The Applicants note that due to PMD the degree of polarization of optical signals can significantly decrease as the signals propagate along an optical communication line and that a suitable repolarization of the signals within and/or at the output end of the line allows the PMD of the line to be remarkably reduced and, therefore, the performance of the optical communication system to be improved. Depending on the length of the line and/or on the DGD mean value of the line, it may be advantageous to locate the PMD mitigation apparatus of the invention within the optical line (instead of or as well as at the end of the link), as disclosed in the international patent application PCT/IT02/00708.

In FIG. 11 an example of WDM optical communication line 1 for transmitting a plurality of WDM optical signals is shown. The line 1 comprises two optical fiber spans 10, two optical line amplifiers 12 to amplify the optical signals at the end of each span 10 and a PMD mitigation apparatus 19 inserted between one span and another.

As to the structural and functional features of the PMD mitigation apparatus 19 reference is made to what disclosed above.

Each span 10 comprises a transmission optical fiber length 11. Typically, the transmission optical fiber length 11 comprises a conventional optical fiber typically used for long-haul signal transmission, preferably of the single mode type.

Typically, the transmission optical fiber length 11 has a length of some tens of Km. For example 80 or 100 Km.

Typically, the optical line amplifiers 12 are of the active optical fiber of the type disclosed above. Thus, as to the structural and functional features of the optical amplifiers 12 reference is made to what disclosed above with reference to the optical amplifier 24. Indeed, the optical amplifier 24 disclosed above may be an optical line amplifier.

The optical amplifiers 12 can possibly comprise more than one optical amplification stage.

In a preferred embodiment the communication line 1 also comprises a chromatic dispersion compensation device (not shown).

The chromatic dispersion compensation device can be any device conventionally known for chromatic dispersion compensation. For example, it can comprise an optical fiber having high chromatic dispersion values (typically at least 20 ps/(nm*Km), in absolute value, at the central wavelength of the optical signals) or a fiber optic grating.

In an embodiment, the PMD mitigation apparatus 19 is positioned downstream both the optical fiber length 11 and the chromatic dispersion compensation device so as to compensate for the PMD introduced by both. Alternatively, the PMD mitigation apparatus 19 can be positioned downstream the optical fiber length 11 and upstream the chromatic dispersion compensation device. According to another alternative, two PMD mitigation apparatus 19 can be provided for, one downstream the optical fiber length 11 to compensate for the PMD introduced by such an optical fiber 11 and one downstream the chromatic dispersion compensation device to compensate for the PMD introduced by the latter device.

Even if in the embodiment illustrated in FIG. 11 only two fiber optic spans 10 are shown with a PMD mitigation apparatus 19 placed between them, the line 1 can also comprise a greater number of spans. In this case, the line 1 can also comprise a plurality of PMD mitigation apparatuses 19 arranged between one span and the next and, possibly, also at the end of the last span. The number and the position of the apparatuses 19 shall be selected so as to effectively compensate for the effects of the PMD of the line 1 according to the system parameters and requirements. For example, in the case of spans with a high PMD with respect to the other spans, they will be positioned downstream of the high PMD spans or both upstream and downstream of such spans.

FIG. 12 shows a WDM optical communication system 2 comprising a transmitting station 50, an optical communication line 1 and a receiving station 40.

In turn, the line 1 comprises a plurality of fiber optic spans 10, a plurality of optical amplifiers 12 and a plurality of PMD mitigation apparatuses 19.

As far as the description of the spans 10, of the optical amplifiers 12 and of the PMD mitigation apparatuses 19 and the number and positioning of the apparatuses 19 along the line 1 are concerned, reference is made to what stated above.

Moreover, even if not shown in the figures, the optical communication system 2 preferably also comprises a suitable number of conventional chromatic dispersion compensation devices (and, possibly, a further suitable number of PMD mitigation apparatuses 19 associated with them).

Typically, the transmitting station 50 comprises a plurality of laser sources adapted to supply a plurality of optical signals with wavelengths different from each other, a corresponding plurality of optical modulators, at least one wavelength division multiplexer device and an optical power amplifier (not shown).

The transmitting station 50 can also comprise a chromatic dispersion precompensation section.

The laser sources are adapted to emit continuous optical signals at the typical wavelengths of fiber optic telecommunications like, for example, in the range of about 1300-1700 nm and, typically, in the third transmission window of optical fibers around 1500-1700 nm.

Typical channel spacings may be 25, 50, 100, 200 GHz.

Typically, the optical modulators are conventional amplitude modulators, for example, of the Mach Zehnder interferometric type. They are driven by respective electrical signals carrying the main information to be transmitted along the optical communication line 1 so as to modulate the intensity of the continuous optical signals in output from the laser sources and to supply a plurality of optical signals at a predetermined bit rate. For example, said bit rate is 2.5 Gbit/s, 10 Gbit/s or 40 Gbit/s.

The optical signals thus modulated are then wavelength multiplexed by one or more multiplexer devices arranged in one or more multiplexing sub bands.

Such multiplexer devices comprise, for example, a conventional fused fiber or planar optical coupler, a Mach-Zehnder device, an AWG (Arrayed Waveguide Grating), an interference filter and/or a micro-optic filter and the like.

The multiplexed optical signals in output from the multiplexer device are then amplified by the optical power amplifier and sent along the optical communication line 1.

The optical power amplifier is, for example, a conventional active optical fiber amplifier doped with erbium as described above.

The receiving station 40 typically comprises at least one demultiplexer device and a plurality of photodetectors (not shown).

The demultiplexer device comprises one or more conventional devices, arranged in one or more demultiplexing sub bands, adapted to separate from each other the optical signals at different wavelength.

Such devices comprise, for example, a conventional fused fiber or planar optics coupler, a Mach-Zehnder device, an AWG (Arrayed Waveguide Grating), an interference filter and/or a micro-optic filter and the like.

The optical signals in output from the demultiplexer device are then converted into corresponding electrical signals by the corresponding plurality of photodetectors.

These photodetectors are, for example, conventional photodiodes.

The electrical signals in output from the photodetectors are then processed depending on the applications.

It will be apparent to those skilled in the art that many changes or additions can be made in the embodiments described without departing from the scope of the present invention.

For example, even if they are not described in detail, the teachings of the invention applied in analogous manner also to the case of bidirectional signal transmission along the optical communication line 1. In this case, the PMD of the outgoing optical signals and of the return optical signals will be compensated independently from each other with two suitable PMD mitigation apparatuses 19.

Moreover, in the PMD mitigation apparatus of any of FIGS. 3-7, instead of tapping a power portion of the aggregate of polarized optical signals from the output 63, a power portion of each polarized signal may be tapped from the exit of the respective polarizer 22 (or 18). Then, all the tapped power portions may be suitably combined to be supplied to the optical control unit 17 which is adapted to process the power of the polarized optical signals as a whole.

A PMD mitigation apparatus according to this latter embodiment may, for example, be used at the receiving station of an optical communication system without the multiplexer 27 or the reflecting element 31. In this way the polarized optical signals are not combined after propagation through the optical paths and can be directly processed one by one by the receiving station.

1-19. (canceled)

20. A PMD mitigation apparatus for mitigating the effects of PMD of a plurality of input optical signals, comprising:
a processing unit having a first input for the plurality of input optical signals, a second input and an output; and
a feedback control unit having an input coupled to the output of the processing unit and an output coupled to the second input of the processing unit, wherein under the control of a control signal,
the processing unit is adapted to act on the polarization of the plurality of input optical signals separately so as to obtain at its output an aggregate comprising a corresponding plurality of polarized optical signals having associated a maximum fraction of power of the plurality of input optical signals; and
the feedback control unit is adapted to receive at its input a power portion of the aggregate comprising the plurality of polarized optical signals, to process said optical power portion so as to generate said control signal and to supply said control signal to the second input of the processing unit.

21. The PMD mitigation apparatus according to claim 20, wherein, the processing unit comprises a plurality of optical paths, one for each of said plurality of optical signals.

22. The PMD mitigation apparatus according to claim 21, wherein each optical path comprises a device adapted to act on the polarization of the respective optical signal.

23. The PMD mitigation apparatus according to claim 22, wherein said device acting on the polarization of the respective optical signal comprises a polarization controller adapted to adjust the polarization of the respective optical signal under the control of the control signal supplied by the feedback control unit.

24. The PMD mitigation apparatus according to claim 23, wherein the processing unit comprises, at the exit of the plurality of optical paths, a polarizer acting on the plurality of optical signals so as to obtain at its output the plurality of polarized optical signals all polarized according to a same predetermined state of polarization, the adjustment introduced by the polarization controllers in each optical path being such as to maximize the optical power associated with the aggregate of said polarized optical signals in output from the polarizer.

25. The PMD mitigation apparatus according to claim 23, wherein each optical path further comprises a polarizer acting on the respective optical signal so as to obtain at its output a polarized optical signal according to a predetermined state of polarization, the adjustment introduced by the polarization controllers in each optical path being such as to maximize the optical power associated with the aggregate of said polarized optical signals in output from the processing unit.

26. The PMD mitigation apparatus according to claim 22, wherein said device adapted to act on the polarization of the respective optical signal comprises a tunable polarizer which, under the control of the control signal supplied by the feedback unit, is adapted to obtain in output a respective polarized optical signal so as to maximize the optical power associated with the aggregate of said polarized optical signals in output from the processing unit.

27. The PMD mitigation apparatus according to claim 21, wherein the processing unit further comprises a separation/combination device adapted to separate the plurality of input optical signals and to supply each signal to the respective optical path.

28. The PMD mitigation apparatus according to claim 27, wherein said separation/combination device is also adapted to collect the optical signals after propagation along the respective optical paths and to combine them again.

29. The PMD mitigation apparatus according to claim 27, wherein said separation/combination device comprises a demultiplexing device having an input for receiving said plurality of input optical signals and a plurality of outputs connected to respective inputs of said plurality of optical paths, said demultiplexing device being adapted to separate said input optical signals and to supply them to the respective optical paths.

30. The PMD mitigation apparatus according to claim 29, wherein said separation/combination device also comprises a multiplexing device having a plurality of inputs connected to respective outputs of said plurality of optical paths and an output, said multiplexing device being adapted to combine on said output the optical signals coming from the plurality of optical paths.

31. The PMD mitigation apparatus according to claim 29, wherein said separation/combination device comprises an optical circulator having an input port for the plurality of input optical signals and a plurality of ports, each connected to one of the optical paths.

32. The PMD mitigation apparatus according to claim 31, wherein the optical circulator also comprises an output port for the optical signals coming from the optical paths.

33. The PMD mitigation apparatus according to claim 31, wherein each optical path comprises, at a first end thereof in proximity to the respective port of the optical circulator, a pass band filter adapted to let the respective optical signal pass and to reflect back the other optical signals.

34. The PMD mitigation apparatus according to claim 33, wherein each optical path also comprises, at a second end thereof opposite the first end, a reflecting element adapted to reflect back, toward the respective port of the optical circulator, the respective optical signal.

35. An optical communication line for transmitting a plurality of optical signals, comprising at least one span and at least one PMD mitigation apparatus according to any one of claims 20 to 34.

36. The optical communication line according to claim 35, wherein the PMD mitigation apparatus is located between two spans of the line.

37. An optical communication system comprising an optical communication line according to claim 35, a transmitting station adapted to supply the plurality of optical signals to the line and a receiving station to receive the plurality of optical signals from the line.

38. A method for mitigating the effects of PMD of a plurality of optical signals, said method comprising the steps of:
a) acting, under the control of a control signal, on the polarization of the plurality of optical signals separately so as to obtain an aggregate of a corresponding plurality of polarized optical signals;
b) providing a power portion of the aggregate of the plurality of polarized optical signals; and
c) processing the optical power portion provided in step b) so as to generate the control signal to be used in step a) so that the aggregate of the corresponding plurality of polarized optical signals has associated a maximum fraction of power of the aggregate of said plurality of optical signals.
